(19) United States
(12) Patent Application Publication
(10) Pub. No.: US 2017/0097680 A1
(43) Pub. Date: Apr. 6, 2017

(54) USING ANISOTROPIC WEAVES OF MATERIALS IN INPUT INTERFACES FOR A VIRTUAL REALITY SYSTEM

(71) Applicant: Oculus VR, LLC, Menlo Park, CA (US)

(72) Inventors: Sean Jason Keller, Kirkland, WA (US); Tristan Thomas Trutna, Seattle, WA (US)

(21) Appl. No.: 15/282,620

(22) Filed: Sep. 30, 2016

Related U.S. Application Data
(60) Provisional application No. 62/236,839, filed on Oct. 2, 2015.

(51) Int. Cl. G06F 3/01; G02B 27/00; G02B 27/02; A63F 13/21

(52) U.S. Cl. CPC G06F 3/014; A63F 13/21; G06F 3/016; G02B 27/0025; G02B 27/027; A63F 2300/8082; G09G 2300/0452; G09G 3/2003

(57) ABSTRACT

A control for a virtual reality (VR) system contacting areas of user's body is comprised of one or more materials having different stiffnesses at different positions of the control. In various embodiments, portions of the control contacting an area of the user's body with a relatively limited range of motion comprise stiffly woven material to limit movement of the control. Conversely, portions of the control contacting an area of the user's body with a relatively larger range or motion comprise softly woven material to allow the control to more easily move as the corresponding area of the user's body moves.

### CROSS REFERENCE TO RELATED APPLICATION

This application claims priority to U.S. Application No. 62/236,839, filed Oct. 2, 2015, which is incorporated by reference in its entirety.

### BACKGROUND

The present disclosure generally relates to controls for virtual reality systems, and specifically relates to controls for a virtual reality system providing tactile feedback without encumbering a user's movement.

Virtual reality (VR) systems typically provide multiple types of sensory output to a user, such as audio and video data presented by a VR headset and audio system, respectively. By providing different types of sensory output, a VR system provides the user with an illusion that the user is immersed in a virtual world generated by the VR system. Additionally, a VR system may include an input interface, such as a glove, that detects position, acceleration, orientation, and other information associated with a portion of the user's body (e.g., the user's hand) and provides the information as input to the VR system. Based on the input from the input interface based on movement of the user in the real world, the VR system may move a corresponding item in the virtual world (e.g., a hand or other appendage belonging to a character in the virtual world). An input interface also facilitates user interaction with other objects in the virtual world. For example, the VR system allows the user to manipulate virtual objects by touching them, picking them up, and moving them through movement of the input interface

### SUMMARY

A control for a virtual reality (VR) system contacting areas of user's body is comprised of one or more materials having different stiffnesses at different positions of the control. In various embodiments, portions of the control contacting an area of the user's body with a relatively limited range of motion comprise stiffly woven material to limit movement of the control. Conversely, portions of the control contacting an area of the user's body with a relatively larger range or motion comprise softly woven material to allow the control to more easily move as the corresponding area of the user's body moves. Additionally, the stiffness of a portion of the control contacting an area of the user's body may be determined based on the stiffness of the area of the user's body. Hence, more rigid portions of the user's body are contacted by portions of the control that comprise stiffly woven material, while less rigid portions of the user's body are contacted by portions of the control that are more softly woven. Using different material stiffnesses for different portions of the control allows the user to more easily move parts of the user's body contacting less stiff portions of the control while also allowing the VR system to provide more effective tactile feedback by applying force to stiffer portions of the control (e.g., via actuators coupled to the stiffer portions of the control).

### BRIEF DESCRIPTION OF THE DRAWINGS

FIG. 1 is a block diagram of a system environment including a virtual reality system, in accordance with an embodiment.

FIG. 2 is a diagram of a glove for use in a virtual reality system, in accordance with an embodiment.

The figures depict embodiments of the present disclosure for purposes of illustration only. One skilled in the art will readily recognize from the following description that alternative embodiments of the structures and methods illustrated herein may be employed without departing from the principles, or benefits touted, of the disclosure described herein.

### DETAILED DESCRIPTION

### System Overview

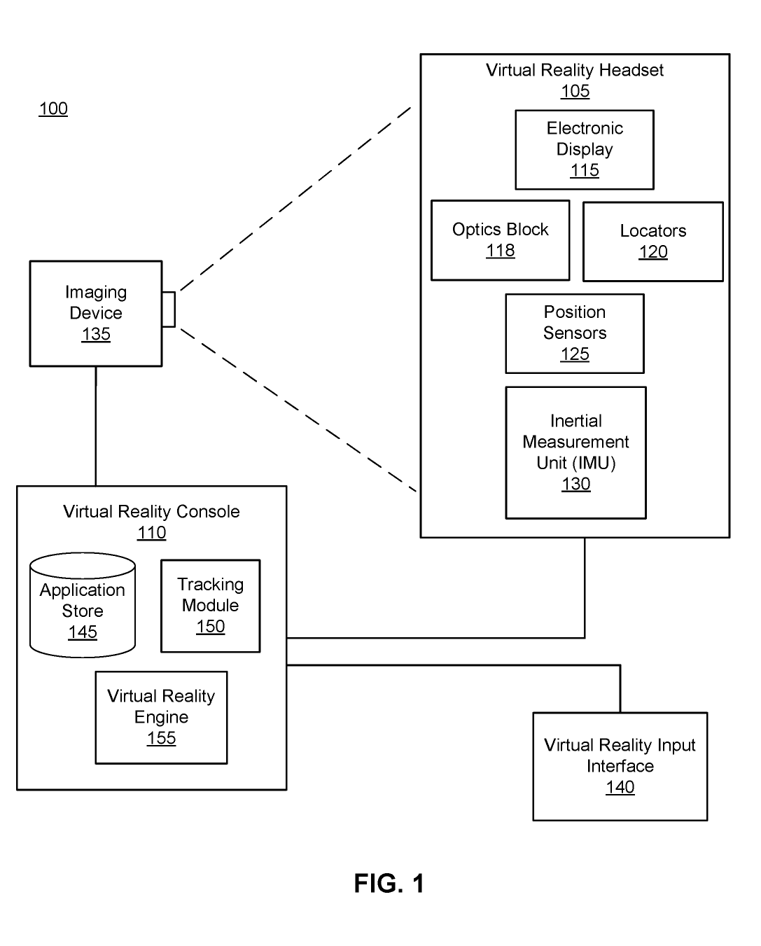

FIG. 1 is a block diagram of a virtual reality (VR) system environment 100 in which a VR console 110 operates. The system environment 100 shown by FIG. 1 comprises a VR headset 105, an imaging device 135, and a VR input interface 140 that are each coupled to the VR console 110. While FIG. 1 shows an example system 100 including one VR headset 105, one imaging device 135, and one VR input interface 140, in other embodiments any number of these components may be included in the system 100. For example, there may be multiple VR headsets 105 each having an associated VR input interface 140 and being monitored by one or more imaging devices 135, with each VR headset 105, VR input interface 140, and imaging devices 135 communicating with the VR console 110. In alternative configurations, different and/or additional components may be included in the system environment 100.

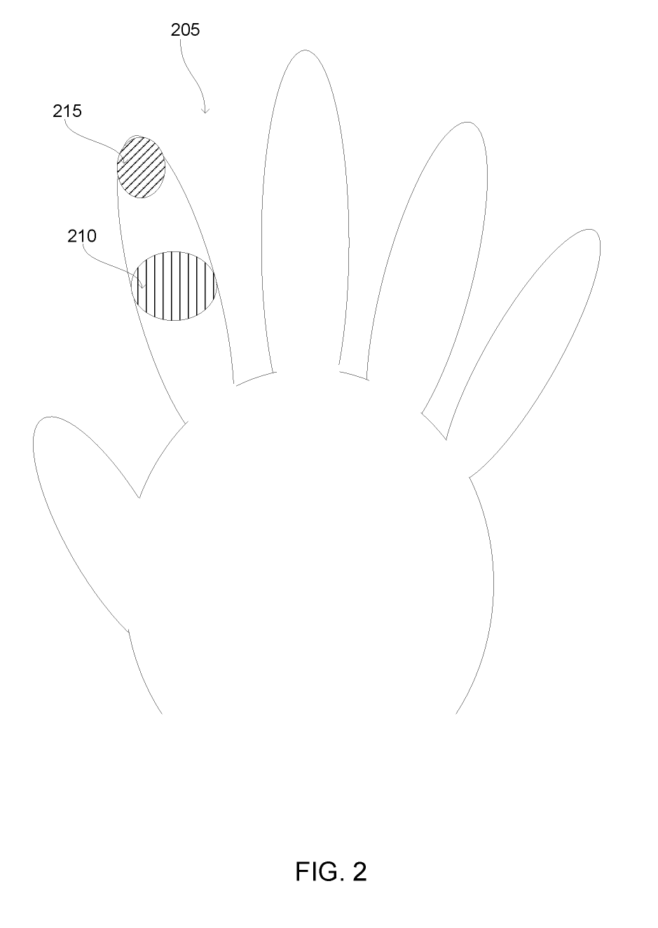

The VR headset 105 is a head-mounted display that presents media to a user. Examples of media presented by the VR head set include one or more images, video, audio, or some combination thereof. In some embodiments, audio is presented via an external device (e.g., speakers and/or headphones) that receives audio information from the VR headset 105, the VR console 110, or both, and presents audio data based on the audio information. An embodiment of the VR headset 105 is further described below in conjunction with FIGS. 2A and 2B. The VR headset 105 may comprise one or more rigid bodies, which may be rigidly or non-rigidly coupled to each other together. A rigid coupling between rigid bodies causes the coupled rigid bodies to act as a single rigid entity. In contrast, a non-rigid coupling between rigid bodies allows the rigid bodies to move relative to each other.

The VR headset 105 includes an electronic display 115, a corrective element 116, an optics block 118, one or more locators 120, one or more position sensors 125, and an inertial measurement unit (IMU) 130. The electronic display 115 displays images to the user in accordance with data received from the VR console 110. In various embodiments, the electronic display 115 may comprise a single electronic display or multiple electronic displays (e.g., a display for each eye of a user). Examples of the electronic display 115 include: a liquid crystal display (LCD), an organic light emitting diode (OLED) display, an active-matrix organic light-emitting diode display (AMOLED), some other display, or some combination thereof.

The electronic display 115 includes a display area comprising a plurality of sub-pixels, where a sub-pixel is a discrete light emitting component. Different sub-pixels are separated from each other by dark space. For example, a sub-pixel emits red light, yellow light, blue light, green light, white light, or any other suitable color of light. In some embodiments, images projected by the electronic display 115 are rendered on the sub-pixel level. This is distinct from, say an RGB (red-green-blue) layout, which has discrete red, green, and blue pixels (red, green, and blue) and each pixel in the RGB layout includes a red sub-pixel, which is adjacent to a green sub-pixel that is adjacent to a blue sub-pixel; the red, green, and blue sub-pixels operate together to form different colors. In an RGB layout a sub-pixel in a pixel is restricted to working within that pixel. However, in some embodiments, sub-pixels in the electronic display operate within multiple “logical” pixels in their surrounding vicinity to form different colors. The sub-pixels are arranged on the display area of the electronic display 115 in a sub-pixel array. Examples of a sub-pixel array include PENTILE® RGBG, PENTILE® RGBW, some another suitable arrangement of sub-pixels that renders images at the sub-pixel level. In some embodiments, one or more adjacent sub-pixels are of the same color.

In various embodiments, the display area of the electronic display 115 arranges sub-pixels in a hexagonal layout, in contrast to a rectangular layout used by conventional RGB type systems. Moreover, some users are more comfortable viewing images which appear to have been generated via a rectangular layout of sub-pixels. In embodiments where the sub-pixels are arrayed hexagonally, the corrective element 116 may be configured to generate amounts of blur that causes the array of sub-pixels in the image presented to the user to appear to be arrayed in a rectangular layout.

The optics block 118 magnifies received light, corrects optical errors associated with the image light, and presents the corrected image light is presented to a user of the VR headset 105. An optical element may be an aperture, a Fresnel lens, a convex lens, a concave lens, a filter, or any other suitable optical element that affects the blurred image light. Moreover, the optics block 118 may include combinations of different optical elements. In some embodiments, one or more of the optical elements in the optics block 118 may have one or more coatings, such as anti-reflective coatings.

Magnification of the image light by the optics block 118 allows the electronic display 115 to be physically smaller, weigh less, and consume less power than larger displays. Additionally, magnification may increase a field of view of the displayed media. For example, the field of view of the displayed media is such that the displayed media is presented using almost all (e.g., 110 degrees diagonal), and in some cases all, of the user's field of view.

The optics block 118 may be designed to correct one or more types of optical error. Examples of optical error include: two dimensional optical errors, three dimensional optical errors, or some combination thereof. Two dimensional errors are optical aberrations that occur in two dimensions. Example types of two dimensional errors include: barrel distortion, pincushion distortion, longitudinal chromatic aberration, transverse chromatic aberration, or any other type of two-dimensional optical error. Three dimensional errors are optical errors that occur in three dimensions. Example types of three dimensional errors include spherical aberration, comatic aberration, field curvature, astigmatism, or any other type of three-dimensional optical error. In some embodiments, content provided to the electronic display 115 for display is pre-distorted, and the optics block 118 corrects the distortion when is receives image light from the electronic display 115 generated based on the content.

The locators 120 are objects located in specific positions on the VR headset 105 relative to one another and relative to a specific reference point on the VR headset 105. A locator 120 may be a light emitting diode (LED), a corner cube reflector, a reflective marker, a type of light source that contrasts with an environment in which the VR headset 105 operates, or some combination thereof. In embodiments where the locators 120 are active (i.e., an LED or other type of light emitting device), the locators 120 may emit light in the visible band (˜380 nm to 750 nm), in the infrared (IR) band (˜750 nm to 1 mm), in the ultraviolet band (10 nm to 380 nm), some other portion of the electromagnetic spectrum, or some combination thereof.

In some embodiments, the locators 120 are located beneath an outer surface of the VR headset 105, which is transparent to the wavelengths of light emitted or reflected by the locators 120 or is thin enough to not substantially attenuate the wavelengths of light emitted or reflected by the locators 120. Additionally, in some embodiments, the outer surface or other portions of the VR headset 105 are opaque in the visible band of wavelengths of light. Thus, the locators 120 may emit light in the IR band under an outer surface that is transparent in the IR band but opaque in the visible band.

The IMU 130 is an electronic device that generates fast calibration data based on measurement signals received from one or more of the position sensors 125. A position sensor 125 generates one or more measurement signals in response to motion of the VR headset 105. Examples of position sensors 125 include: one or more accelerometers, one or more gyroscopes, one or more magnetometers, another suitable type of sensor that detects motion, a type of sensor used for error correction of the IMU 130, or some combination thereof. The position sensors 125 may be located external to the IMU 130, internal to the IMU 130, or some combination thereof.

Based on the one or more measurement signals from one or more position sensors 125, the IMU 130 generates fast calibration data indicating an estimated position of the VR headset 105 relative to an initial position of the VR headset 105. For example, the position sensors 125 include multiple accelerometers to measure translational motion (forward/back, up/down, left/right) and multiple gyroscopes to measure rotational motion (e.g., pitch, yaw, roll). In some embodiments, the IMU 130 rapidly samples the measurement signals and calculates the estimated position of the VR headset 105 from the sampled data. For example, the IMU 130 integrates the measurement signals received from the accelerometers over time to estimate a velocity vector and integrates the velocity vector over time to determine an estimated position of a reference point on the VR headset 105. Alternatively, the IMU 130 provides the sampled measurement signals to the VR console 110, which determines the fast calibration data. The reference point is a point that may be used to describe the position of the VR headset 105. While the reference point may generally be defined as a point in space; however, in practice the reference point is defined as a point within the VR headset 105 (e.g., a center of the IMU 130).

The IMU 130 receives one or more calibration parameters from the VR console 110. As further discussed below, the one or more calibration parameters are used to maintain tracking of the VR headset 105. Based on a received calibration parameter, the IMU 130 may adjust one or more IMU parameters (e.g., sample rate). In some embodiments, certain calibration parameters cause the IMU 130 to update an initial position of the reference point so it corresponds to a next calibrated position of the reference point. Updating the initial position of the reference point as the next calibrated position of the reference point helps reduce accumulated error associated with the determined estimated position. The accumulated error, also referred to as drift error, causes the estimated position of the reference point to “drift” away from the actual position of the reference point over time.

The imaging device 135 generates slow calibration data in accordance with calibration parameters received from the VR console 110. Slow calibration data includes one or more images showing observed positions of the locators 120 that are detectable by the imaging device 135. The imaging device 135 may include one or more cameras, one or more video cameras, any other device capable of capturing images including one or more of the locators 120, or some combination thereof. Additionally, the imaging device 135 may include one or more filters (e.g., used to increase signal to noise ratio). The imaging device 135 is configured to detect light emitted or reflected from locators 120 in a field of view of the imaging device 135. In embodiments where the locators 120 include passive elements (e.g., a retroreflector), the imaging device 135 may include a light source that illuminates some or all of the locators 120, which retro-reflect the light towards the light source in the imaging device 135. Slow calibration data is communicated from the imaging device 135 to the VR console 110, and the imaging device 135 receives one or more calibration parameters from the VR console 110 to adjust one or more imaging parameters (e.g., focal length, focus, frame rate, ISO, sensor temperature, shutter speed, aperture, etc.).

The VR input interface 140 is a device that allows a user to send action requests to the VR console 110. An action request is a request to perform a particular action. For example, an action request may be to start or end an application or to perform a particular action within the application. The VR input interface 140 may include one or more input devices. Example input devices include: a keyboard, a mouse, a game controller, or any other suitable device for receiving action requests and communicating the received action requests to the VR console 110. An action request received by the VR input interface 140 is communicated to the VR console 110, which performs an action corresponding to the action request. In some embodiments, the VR input interface 140 may provide haptic feedback to the user in accordance with instructions received from the VR console 110. For example, haptic feedback is provided when an action request is received, or the VR console 110 communicates instructions to the VR input interface 140 causing the VR input interface 140 to generate haptic feedback when the VR console 110 performs an action. In various embodiments, the VR input interface 140 includes one or more controls, which are further described below in conjunction with FIG. 2, contacting areas of a user's body and receiving action requests based on movement of one or more areas of the user's body. For example, the VR input interface 140 includes a glove that identifies action requests based on movements of the user's hand and communicates the action request to the VR console 110. A control included in the VR input interface 140 may also provide haptic or other tactile feedback when the VR console 110 performs an action or receives an action request. For example, a control includes one or more actuators that apply pressure, tension, or vibration to an area of the user's body contacting a portion of the control including the actuator. Hence, haptic or tactile feedback produced by the VR input interface 140 allows a user to simulate physical interaction with content presented by the VR headset 105.

The VR console 110 provides media to the VR headset 105 for presentation to the user in accordance with information received from one or more of: the imaging device 135, the VR headset 105, and the VR input interface 140. In the example shown in FIG. 1, the VR console 110 includes an application store 145, a tracking module 150, and a virtual reality (VR) engine 155. Some embodiments of the VR console 110 have different modules than those described in conjunction with FIG. 1. Similarly, the functions further described below may be distributed among components of the VR console 110 in a different manner than is described here.

The application store 145 stores one or more applications for execution by the VR console 110. An application is a group of instructions, that when executed by a processor, generates content for presentation to the user. Content generated by an application may be in response to inputs received from the user via movement of the HR headset 105 or the VR interface device 140. Examples of applications include: gaming applications, conferencing applications, video playback application, or other suitable applications.

The tracking module 150 calibrates the VR system 100 using one or more calibration parameters and may adjust one or more calibration parameters to reduce error in determination of the position of the VR headset 105. For example, the tracking module 150 adjusts the focus of the imaging device 135 to obtain a more accurate position for observed locators on the VR headset 105. Moreover, calibration performed by the tracking module 150 also accounts for information received from the IMU 130. Additionally, if tracking of the VR headset 105 is lost (e.g., the imaging device 135 loses line of sight of at least a threshold number of the locators 120), the tracking module 140 re-calibrates some or all of the system environment 100.

The tracking module 150 tracks movements of the VR headset 105 using slow calibration information from the imaging device 135. As further described below in conjunction with FIG. 3, the tracking module 150 determines positions of a reference point of the VR headset 105 using observed locators from the slow calibration information and a model of the VR headset 105. The tracking module 150 also determines positions of a reference point of the VR headset 105 using position information from the fast calibration information. Additionally, in some embodiments, the tracking module 150 may use portions of the fast calibration information, the slow calibration information, or some combination thereof, to predict a future location of the headset 105. The tracking module 150 provides the estimated or predicted future position of the VR headset 105 to the VR engine 155.

The VR engine 155 executes applications within the system environment 100 and receives position information, acceleration information, velocity information, predicted future positions, or some combination thereof of the VR headset 105 from the tracking module 150. Based on the received information, the VR engine 155 determines content to provide to the VR headset 105 for presentation to the user. For example, if the received information indicates that the user has looked to the left, the VR engine 155 generates content for the VR headset 105 that mirrors the user's movement in a virtual environment. Additionally, the VR engine 155 performs an action within an application executing on the VR console 110 in response to an action request received from the VR input interface 140 and provides feedback to the user that the action was performed. The provided feedback may be visual or audible feedback via the VR headset 105 or haptic feedback via the VR input interface 140.

FIG. 2 is a diagram of a control included in a VR input interface 140 of a VR system 100. For purposes of illustration, FIG. 2 shows a glove 205 as an example control included in the VR input interface 140. However, in other embodiments, the control may be any suitable article contacting a portion of a user's body. In various embodiments, the glove 205 (or other control) comprises a material (e.g., fabric) or combination of materials having a pattern or shape.

The glove 205 in FIG. 2 comprises a material having an anisotropic weave pattern so a different stiffness may be associated with different portions of the glove 205. Anisotropic materials are materials having directionally dependent properties, so an anisotropic material exhibits different properties when oriented in different directions. An example anisotropic material has greater rigidity when horizontally oriented relative to a reference point than when vertically oriented relative to a reference point. Another example anisotropic material has greater rigidity when vertically oriented relative to a reference point than when horizontally oriented relative to a reference point. Hence, differently orienting the weave pattern of an anisotropic material comprising different portions of the glove 205 cause the different portions of the glove 205 to have different properties, such as different stiffnesses or different rigidities. The stiffness of a portion of the glove 205 affects an ability of the portion of the glove 205 to move in one or more directions. For example, a portion of the glove 205 having a higher stiffness is more resistant to movement than another portion of the glove 205 having a lower stiffness. Hence, the stiffness of a portion of the glove 205 may restrict movement of a portion of the glove 205 in a particular direction. For example, a portion of the glove 205 has a higher stiffness to movement in a an upward direction, making it difficult to move the portion in the upward direction, while having a lower stiffness to movement in a downward direction, allowing the portion to more easily move in the downward direction.

In various embodiments, the glove 205 comprises one or more woven materials positioned so that portions of the material having a stiff weave correspond to stiff areas of a user's hand, while portions of the material having a softer weave correspond to soft areas of the user's hand. For example, a portion of the glove 205 positioned proximate to a stiff area of the user's hand comprises a material having an anisotropic weave pattern providing greater than a threshold stiffness in a direction of motion and an alternative portion of the glove 205 positioned proximate to a soft area of the user's hand comprises a material having anisotropic weave pattern having less than the threshold stiffness in the direction of motion. This positioning of stiffly woven portions of the material and softly woven portions of the material allows the glove 205 to constrain movement of the stiff areas of the user's hand while affording the user a larger range of motion for soft areas of the user's hand while wearing the glove 205. Hence, the user may more easily move its hand while wearing the glove 205, simplifying interaction with objects presented to the user via the VR system 100. Additionally, having stiffly woven portions of the glove 205 allows the VR system 100 to better actuate portions of the glove 205 to provide haptic or tactile feedback to the user via the glove 205 through the stiffly woven portions, while the softly woven portions of the glove 205 allow the user to more easily move its hand while wearing the glove 205.

For example, a model of stiffness of various areas of a hand (or other body part) is determined and the glove 205 is manufactured so relative stiffnesses of different portions of the glove 205 match relative stiffnesses of areas of the hand contacting corresponding portions of the glove 205. In various embodiments, portions of the glove 205 contacting areas of the hand having higher relative stiffnesses than other areas of the hand comprise material that is more stiffly woven than material comprising the glove 205 contacting areas of the hand having lower relative stiffnesses. As an example, a portion of the glove 205 positioned proximate to a stiff portion of the user's head comprises an anisotropic weave pattern having greater than a threshold stiffness in a direction of motion and an alternative portion of the glove 205 positioned proximate to a soft area of the user's hand comprises an alternative anisotropic weave pattern having less than the threshold stiffness in the direction of motion. For example, a joint of a finger has a lower stiffness than a tip of the finger as the joint has a greater range of motion. Accordingly, a portion 210 of the glove 205 contacting the joint comprises a material woven to have a lower stiffness than another portion 215 of the glove 205 contacting the tip of the finger. Hence, movement of the joint of the finger is less encumbered by the glove 205 because of the lower stiffness of the material of the portion 210 of the glove 205 contacting the joint, allowing a user wearing the glove to more easily bend the joint of the finger while wearing the glove. However, the stiffer other portion 215 of the glove 205 contacting the tip of the finger allows the VR system 100 to provide greater haptic feedback to the user via the glove 205 via actuators coupled to the other portion 215 of the glove 205, allowing the provided haptic feedback to more accurately simulate real world interactions.

In some embodiments, the glove 205 is produced by varying the weave of a material to change the stiffness of the material in various portions of the glove 205 contacting different areas of the user's hand. Alternatively, different materials having weaves with different stiffnesses are coupled to each other so materials with different stiffnesses contact different areas of the user's hand based on the stiffnesses of the areas of the user's hand. Additional materials may also be included in the glove 205 (or other control), such as one or more inextensible materials capable of acting as tendons for the glove 205 or providing leads to actuators coupled to portions of the glove 205, which may reduce the size and weight of the glove 205 relative to conventional methods that have tendons or leads externally coupled to the glove 205. In some embodiments, the glove 205 includes one or more materials (e.g., fabrics) having weaves that allow the material where application of tension along a direction of the material allows the material to stretch up to a certain length while becoming inextensible beyond the certain length, which stiffens a region of the material and then become inextensible.

### SUMMARY

The foregoing description of the embodiments of the disclosure has been presented for the purpose of illustration; it is not intended to be exhaustive or to limit the disclosure to the precise forms disclosed. Persons skilled in the relevant art can appreciate that many modifications and variations are possible in light of the above disclosure.

The language used in the specification has been principally selected for readability and instructional purposes, and it may not have been selected to delineate or circumscribe the inventive subject matter. It is therefore intended that the scope of the disclosure be limited not by this detailed description, but rather by any claims that issue on an application based hereon. Accordingly, the disclosed embodiments are intended to be illustrative, but not limiting, of the scope of the disclosure, which is set forth in the following.

What is claimed is:

1. A system comprising:
a console coupled to an electronic display, the console configured to provide content to the electronic display for presentation to a user;
a control coupled to the console, the control comprising an anisotropic material configured to contact one or more portions of a body of the user, the control comprising a plurality of portions, each portion having a different anisotropic weave pattern so a different stiffness is associated with different portions of the control, the anisotropic weave pattern of a portion of the control configured to have an increased stiffness in an orientation relative to a reference point relative to a stiffness in an alternative orientation relative to the reference point.

2. The system of claim 1, wherein the orientation relative to the reference point comprises a vertical orientation relative to the reference point and the alternative orientation relative to the reference point comprises a horizontal orientation relative to the reference point.

3. The system of claim 1, wherein the orientation relative to the reference point comprises a horizontal orientation relative to the reference point and the alternative orientation relative to the reference point comprises a vertical orientation relative to the reference point.

4. The system of claim 1, wherein a portion of the control has an anisotropic weave pattern configured to have a higher stiffness to movement in an upward direction relative to movement in a downward direction.

5. The system of claim 1, wherein a portion of the control positioned proximate to a stiff portion of the body of the user comprises an anisotropic weave pattern having greater than a threshold stiffness in a direction of motion and an alternative portion of the control positioned proximate to a soft area of the body of the user comprises an alternative anisotropic weave pattern having less than the threshold stiffness in the direction of motion.

6. The system of claim 5, further comprising an actuator coupled to the portion of the control positioned proximate to the stiff portion of the user's body, the actuator configured to provide haptic feedback in response to being actuated by the console.

7. The system of claim 1, wherein the control comprises a glove configured to contact one or more portions of a hand of the user.

8. The system of claim 1, wherein portions of the control having different stiffnesses are positioned relative to each other based on a model identifying stiffnesses of different portions of the body of the user.

9. The system of claim 1, wherein portions of the control having different anisotropic weave patterns comprise different materials that have different anisotropic weave patterns.

10. The system of claim 9, wherein a portion of the control configured to contact a portion of the body of the user comprises a material configured to stretch up to a certain length and become inextensible beyond the certain length.

11. An apparatus comprising:
a control for a virtual reality system environment, the control comprising an anisotropic material configured to contact one or more portions of a body of the user, the control comprising a plurality of portions, each portion having a different anisotropic weave pattern so a different stiffness is associated with different portions of the control, the anisotropic weave pattern of a portion of the control configured to have an increased stiffness in an orientation relative to a reference point relative to a stiffness in an alternative orientation relative to the reference point.

12. The apparatus of claim 11, wherein the orientation relative to the reference point comprises a vertical orientation relative to the reference point and the alternative orientation relative to the reference point comprises a horizontal orientation relative to the reference point.

13. The apparatus of claim 11, wherein the orientation relative to the reference point comprises a horizontal orientation relative to the reference point and the alternative orientation relative to the reference point comprises a vertical orientation relative to the reference point.

14. The apparatus of claim 11, wherein a portion of the control has an anisotropic weave pattern configured to have a higher stiffness to movement in an upward direction relative to movement in a downward direction.

15. The apparatus of claim 11, wherein a portion of the control positioned proximate to a stiff portion of the body of the user body comprises an anisotropic weave pattern having greater than a threshold stiffness in a direction of motion and an alternative portion of the control positioned proximate to a soft area of the body of the user comprises an alternative anisotropic weave pattern having less than the threshold stiffness in the direction of motion.

16. The apparatus of claim 15, further comprising an actuator coupled to the portion of the control positioned proximate to the stiff portion of the user's body, the actuator configured to provide haptic feedback in response to being activated.

17. The apparatus of claim 11, wherein the control comprises a glove configured to contact one or more portions of a hand of the user.

18. The apparatus of claim 11, wherein portions of the control having different stiffnesses are positioned relative to each other based on a model identifying stiffnesses of different portions of the body of the user.

19. The apparatus of claim 1, wherein portions of the control having different anisotropic weave patterns comprise different materials that have different anisotropic weave patterns.

20. The apparatus of claim 9, wherein a portion of the control configured to contact a portion of the body of the user comprises a material configured to stretch up to a certain length and become inextensible beyond the certain length.
